(19) United States
(12) Patent Application Publication
(10) Pub. No.: US 2025/0100152 A1
(43) Pub. Date: Mar. 27, 2025

(54) Smart Manipulator Based On Vision-Based Force-Position Fusion Measurement

(71) Applicant: Harbin Institute of Technology, Harbin City (CN)

(72) Inventors: Cheng WEI, Harbin (CN); Shiwei CHEN, Harbin (CN); Peiji WANG, Harbin (CN)

(21) Appl. No.: 18/822,182

(22) Filed: Aug. 31, 2024

(30) Foreign Application Priority Data
Sep. 27, 2023 (CN) 2023112627130

(51) Int. Cl. B25J 9/16; B25J 13/08; B25J 15/00

(52) U.S. Cl. CPC B25J 9/1697; B25J 13/085; B25J 15/0009

(57) ABSTRACT

A smart manipulator based on vision-based force and position fusion measurement, which solves overall bloated structure in the existing manipulator system, includes a thumb, an index finger, a middle finger, a ring finger, a little finger, a palm, two depth cameras and a plurality of drive measurement units, wherein the drive measurement units are evenly distributed to form a truncated cone structure, the two depth cameras are symmetrically arranged on a rear end of the drive measurement units while each depth camera is respectively arranged along a generatrix direction of the truncated cone structure. The palm is arranged at a front end of the drive measurement units, and the five fingers are arranged at a front end of the palm, each of the thumb, the index finger, the middle finger, the ring finger and the little finger are connected to two or more the drive measurement unit respectively.

### BACKGROUND OF THE PRESENT INVENTION

### Field of Invention

The present invention relates to the field of mechanical system design of robots, in particularly related to a smart manipulator based on vision-based force-position fusion measurement.

### Description of Related Arts

With the continuous development of robot technology, higher requirements have been put forward for the ability of robots to carry out complex interactions with the environment. Dexterous hands will gradually replace traditional end effector tools because of their anthropomorphic high degree of freedom and dexterity, and will play a vital role in aerospace, manufacturing, warehousing, smart medical care, robot service industries and other fields. To achieve dexterous operation and control of targets with dexterous hands, it is inseparable from the perception of its own force and position information. Traditional solutions often install angle encoders and torque sensors on each joint of the dexterous hand. However, dexterous hands usually have many degrees of freedom, which requires purchasing an equal number of position sensors and force sensors, which incurs high costs. On the other hand, the installation and wiring of these sensors require additional mechanism design, increase power consumption, restrict the size of the mechanism, and increase the complexity of the entire control system. Therefore, there is an urgent need for a new design and device for measuring dexterous hand strength and position.

Some researchers have proposed a mechanism for measurement integration of force and position, but it is only a proof of principle for a single joint and has not yet been applied to actual robot systems. Therefore, the main contribution of the present invention is to provide a low-cost overall design solution and structural device for dexterous hands with integrated measurement of force and position.

### SUMMARY OF THE PRESENT INVENTION

In order to solve the above problems of bulky overall mechanism in the manipulator system caused by the existing robot force and position sensing links, the present invention provides a smart manipulator with vision-based force and position fusion measurement.

The technical solutions adopted by the present invention to solve the above technical problems are:

A smart manipulator based on vision-based force and position fusion measurement, characterized in that, the manipulator, which comprises: a thumb, an index finger, a middle finger, a ring finger, a little finger, a palm, two depth cameras and a plurality of drive measurement units. The plurality of drive measurement units are evenly distributed to form a truncated cone structure, the two depth cameras are symmetrically arranged on a rear end of the plurality of drive measurement units while each of the depth cameras is respectively arranged along a busbar direction of the truncated cone structure. The term busbar refers to the generatrix of a geometric shape, a truncated cone, in mathematics. The palm is arranged at a front end of the plurality of drive measurement units, and the thumb, the index finger, the middle finger, the ring finger and the little finger are arranged at a front end of the palm, the thumb, the index finger, the middle finger, the ring finger and the little finger are connected to two or more of the drive measurement units respectively.

Furthermore, the thumb, the index finger and the middle finger are all three-wheel-drive finger mechanisms, the three-wheel-drive finger mechanism is connected to three drive measurement units respectively; the ring finger and the little finger are both two-wheel-drive finger mechanisms, the two-wheel-drive finger mechanism is connected to two drive measurement units respectively.

Furthermore, the drive measurement unit comprises a rope, a tension spring, a fixed frame, a driving unit and a linear movement unit, the driving unit is fixed on the fixed frame, an output end of the driving unit is connected to an input end of the linear movement unit, the tension spring is slidingly connected to the fixed frame through a sliding component, an execution end of the linear movement unit is fixedly connected to a rear end of the tension spring, a front end of the tension spring is fixedly connected to one end of the rope, another end of the rope is fixedly connected to the finger joint, the depth camera is positioned to face the tension spring.

Furthermore, both the front end and the rear end of the tension spring are fixedly connected to connecting heads respectively, the connecting heads are slidingly connected to the sliding component, the connecting head at the rear end has one side vertically fixed with a spring B end marking point, the connecting head at the front end has one side vertically fixed with a spring A end marking point.

Furthermore, the linear movement unit comprises a guide rail, a T-shaped screw and a T-shaped nut, the guide rail is mounted on the fixed frame, and the T-shaped screw and the guide rail are arranged in parallel to each other, a rear end of the T-shaped screw is connected to the output end of the driving unit, the T-shaped nut is screwed onto the T-shaped screw, an outside of the T-shaped screw is sleeved on the guide rail, and the rear end of the tension spring is fixedly connected to a front end face of the T-shaped nut.

Furthermore, a connecting rod is vertically fixed between a rear end face of the connecting head at the rear end of the connecting head and a front end face of the T-shaped nut, the connecting rod is inserted into a middle connecting plate and is slidingly connected to the middle connecting plate.

Furthermore, the two-wheel-drive finger mechanism comprises a two-wheel-drive first flexion joint, a two-wheel-drive first flexion knuckle, a two-wheel-drive second flexion joint, a two-wheel-drive second flexion knuckle, a two-wheel-drive third flexion joint and a two-wheel-drive third flexion knuckle, the two-wheel-drive first flexion joint are arranged on the palm, an outer sidewall of the two-wheel-drive first flexion joint is fixed with the rope of the drive measurement units, a front end of the two-wheel-drive first flexion joint is fixed with a rear end of the two-wheel-drive first flexion knuckles, the two-wheel-drive second flexion joint is arranged at a front end of the two-wheel-drive first flexion knuckles, an outer sidewall of the two-wheel-drive second flexion joint are fixed with the rope of the drive measurement units, a front end of the two-wheel-drive second flexion joint is fixed with a rear end of the two-wheel-drive second flexion knuckles, the two-wheel-drive third flexion joint is arranged at a front end of the two-wheel-drive second flexion knuckles, an outer sidewall of the two-wheel-drive third flexion joint is fixed to the outer sidewall of the two-wheel-drive second flexion joint through a two-wheel-drive passive rope, a front end of the two-wheel-drive third flexion joint is fixed with a rear end of the two-wheel-drive third flexion knuckle, two sides of the two-wheel-drive third flexion knuckle are respectively fixed with one end of a two-wheel-drive reset rope, another ends of the two-wheel-drive reset ropes are arranged to bypass outer sides of the two-wheel-drive second flexion joint and the two-wheel-drive first flexion joint respectively and then connected to one end of a two-wheel-drive reset spring respectively, another ends of the two-wheel-drive reset springs are arranged on the palm.

Furthermore, the two-wheel-drive finger mechanism further comprises three two-wheel-drive guide pulleys, all of the three two-wheel-drive guide pulleys are arranged at the front end of the palm, one of the two-wheel-drive guide pulleys is arranged on a rear side of the two-wheel-drive first flexion joint, and another two of the two-wheel-drive guide pulleys are respectively arranged on two sides of an axis of the two-wheel-drive first flexion joint, the rope affixed at the outer sidewall of the two-wheel-drive second flexion joint are arranged to sequentially bypass three the two-wheel-drive guide pulleys and pass through the axis of the two-wheel-drive first flexion joint.

Furthermore, the three-wheel-drive finger mechanism comprises a lateral swing base, a lateral swing joint, a three-wheel-drive first flexion joint, a three-wheel-drive first flexion knuckle, and a three-wheel-drive second flexion joint, a three-wheel-drive second flexion knuckle, a three wheel-drive third flexion joint and a three-wheel-drive first flexion joints knuckle, the lateral swing base is fixed on the palm, the lateral swing joint is arranged on the lateral swing base, an outer sidewall of the lateral swing joint is fixed with the rope of the drive measurement units, a front end of the lateral swing joint is connected to the three-wheel-drive first flexion joint, an outer sidewall of the three-wheel-drive first flexion joint is fixed with the rope of another the drive measurement units, a front end of the three-wheel-drive first flexion joint is fixed with a rear end of the three-wheel-drive first flexion knuckle, the three-wheel-drive second flexion joint is arranged at a front end of the three-wheel-drive first flexion knuckle, an outer sidewall of the three-wheel-drive second flexion joint is fixed with the rope of third the drive measurement units, a front end of the three-wheel-drive second flexion joint is connected to a rear end of the three-wheel-drive second flexion knuckle, the three-wheel-drive second flexion joint is arranged at a front end of the three-wheel-drive second flexion knuckle, an outer sidewall of the three-wheel-drive third flexion joint is fixed to the outer sidewall of the three-wheel-drive second flexion joint through a three-wheel-drive passive rope, a front end of the three-wheel-drive third flexion joint is fixed with a rear end of the three-wheel-drive first flexion joints knuckle, two sides of the three-wheel-drive first flexion joints knuckle are respectively fixed with one end of a three-wheel-drive reset rope, another end of the three-wheel-drive reset rope are arranged to bypass outer sides of the three-wheel-drive second flexion joint and the three-wheel-drive first flexion joint respectively and then connected to one end of a three-wheel-drive reset spring respectively, another end of the three-wheel-drive reset spring is mounted on the palm.

Furthermore, the three-wheel-drive finger mechanism further comprises three three-wheel-drive guide pulleys, all of the three three-wheel-drive guide pulleys are arranged at the front end of the palm, one of the three-wheel-drive guide pulleys is arranged on a rear side of the three-wheel-drive first flexion joint, and another two of the three-wheel-drive guide pulleys are respectively arranged on two sides of an axis of the three-wheel-drive first flexion joint, the rope affixed at the outer sidewall of the three-wheel-drive second flexion joint are arranged to sequentially bypass three the three-wheel-drive guide pulleys and pass through the axis of the three-wheel-drive first flexion joint.

Compared with the existing arts, the advantageous effect of the present invention are as follows:

The object of the present invention is to solve the force and position sensing aspects of the dexterous hand in the traditional solution, which include problems of high cost of the measurement unit, large space occupation, complex mechanism design, increased power consumption, and reduced control stability. At present, similar solutions have been proposed by researchers, but have not yet been realized in actual robotic systems. Therefore, the present invention mainly provides a five-finger dexterous hand system solution and device for fusion measurement of force and position.

The present invention is aimed at a tendon-driven dexterous hand system, and provides a new design scheme. First, a dexterous hand mechanism with 13 degrees of freedom (13 finger joints) is designed. Each joint is stretched by tendons. A tension spring is connected in series between the tendons and the motor. Then the deformation of the spring is measured visually to calculate the rope tension. Then the corresponding joint torque is obtained. At the same time, vision can measure the displacement relative to the initial moment of the top of the spring (the end connected to the tendon), and the joint rotation angle can be obtained through conversion. By specially arranging the wiring of all tendons, it is finally possible to include all springs of the dexterous hand within the visual field of the vision unit, thereby measuring the torque and position information of all joints at the same time. This new design method of dexterous hand can obtain the torque and angle information of all joints of the dexterous hand using only a binocular camera. This eliminates the need for angle sensors, torque sensors and other devices on the 13 finger joints, saving the cost of the mechanism and reducing the size of the mechanism.

### BRIEF DESCRIPTION OF THE DRAWINGS

FIG. 1 is a schematic diagram of the overall structure according to a preferred embodiment of the present invention.

FIG. 2 is a schematic structural diagram of a rear end face of a plurality drive measurement units I according to the preferred embodiment of the present invention.

FIG. 3 is a front view of the hand body according to the preferred embodiment of the present invention.

FIG. 4 is a schematic structural diagram of a two-wheel-drive finger mechanism according to the embodiment of the present invention.

FIG. 5 is a partial enlarged view of FIG. 4.

FIG. 6 is a schematic structural diagram of three two-wheel-drive guide pulleys 35 according to the preferred embodiment of the present invention.

FIG. 7 is a schematic diagram of the winding of the two-wheel-drive finger mechanism according to the preferred embodiment of the present invention.

FIG. 8 is a schematic structural diagram of a three-wheel-drive finger mechanism according to the preferred embodiment of the present invention.

FIG. 9 is a schematic diagram of the winding of the three-wheel-drive finger mechanism according to the preferred embodiment of the present invention.

FIG. 10 is a front view of an overall structure of the drive measurement unit I according to the preferred embodiment of the present invention.

### DETAILED DESCRIPTION OF THE PREFERRED EMBODIMENT

In order to explain further the technical problems, the technical solutions and the advantageous effects of the present invention, the present invention is further described in details below with reference to the drawings and embodiments. It should be understood that the specific embodiments described here are only used to explain the present invention and are not intended to be limiting.

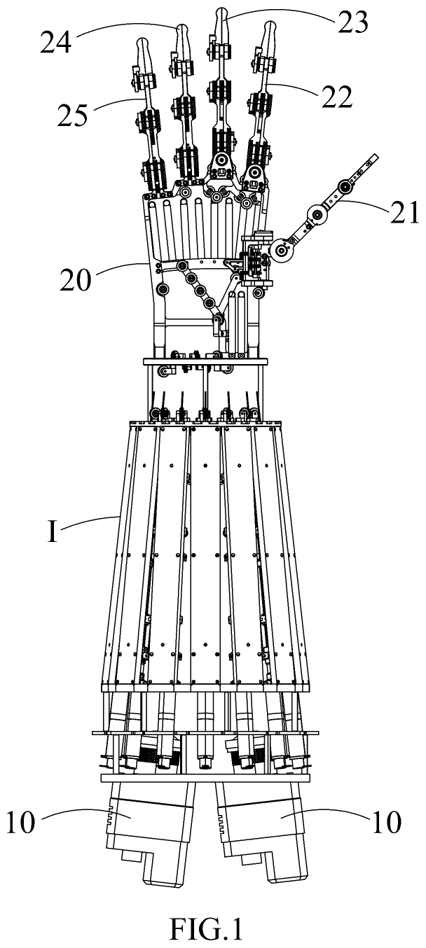

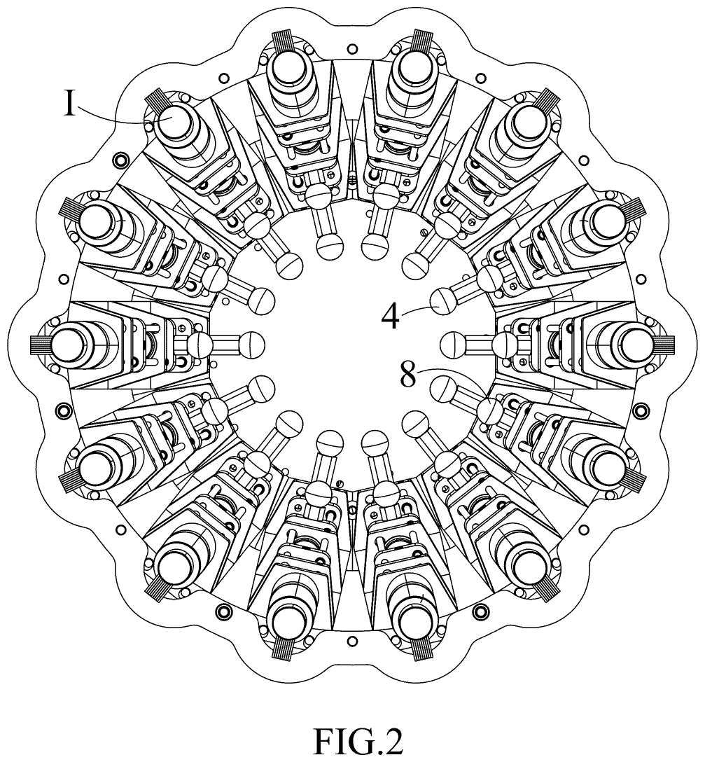

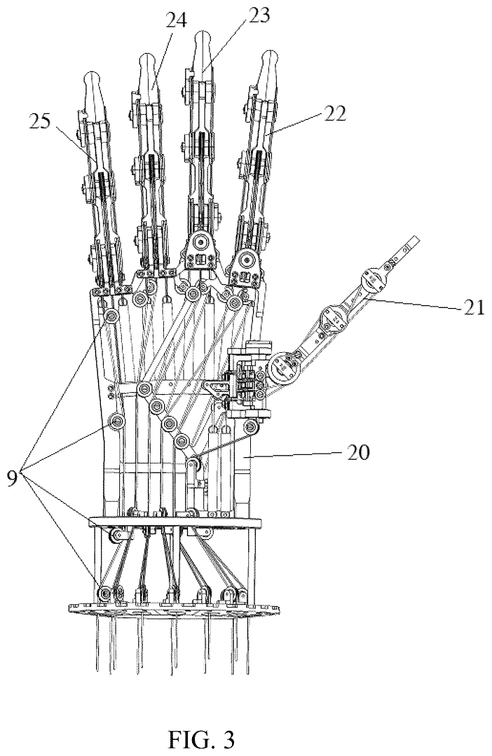

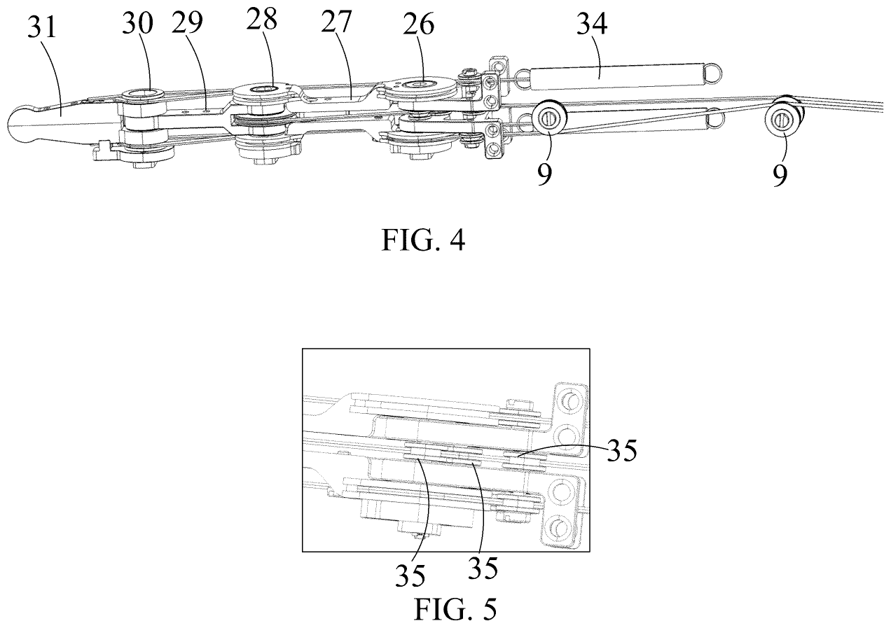

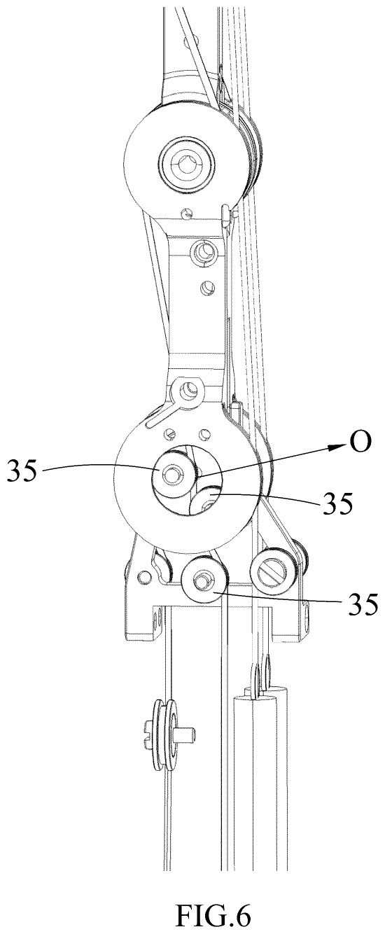

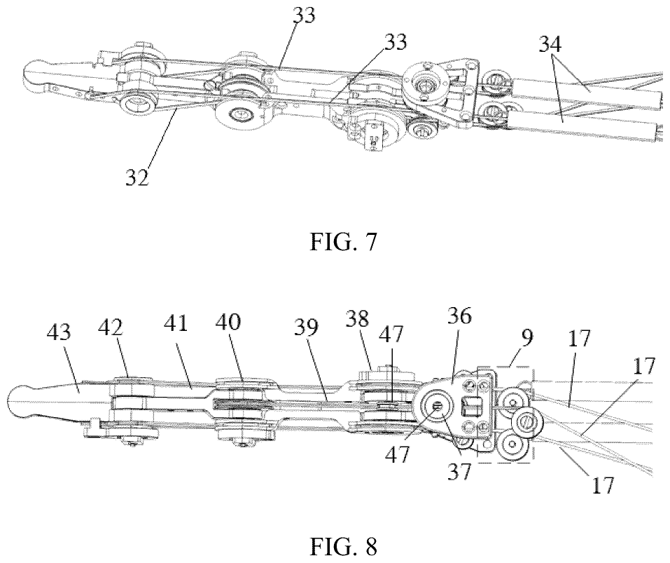

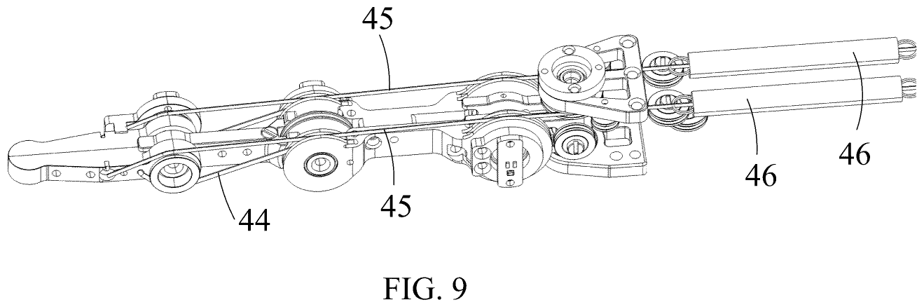

Preferred Embodiment 1: This embodiment is described with reference to FIGS. 1 to 10. According to this embodiment, a smart manipulator with vision-based force and position fusion measurement comprises a thumb 21, an index finger 22, a middle finger 23, a ring finger 24, a little finger 25, a palm 20, two depth cameras 10 and a plurality of drive measurement units I, the plurality of drive measurement units I are evenly distribution to form a truncated cone-shaped structure defining a front end, a rear end, and a side direction extending from the front end to the rear end along a side line (generatrix) of the truncated cone-shaped structure. The two depth cameras 10 are symmetrically arranged on the rear end of the plurality of drive measurement units I, and each depth camera 10 is arranged along a side direction of the truncated cone-shaped structure. The palm 20 is arranged at the front end of the plurality of drive measurement units I. The thumb 21, the index finger 22, the middle finger 23, the ring finger 24 and the little finger 25 are arranged at a front end of the palm 20. The thumb 21, the index finger 22, the middle finger 23, the ring finger 24 and the little finger 25 are respectively connected to the two or more of drive measurement units I.

A new mechanical layout is provided in the vision-based fusion measurement mechanism. The visual device is embedded at the end of the forearm, and then multiple measurement units I are smartly arranged in a circular path. This allows the visual device to observe the spring extension information of all measurement units I at the same time, so as to indirectly measure joint angles, torques and motor encoder data, and at the same time significantly reduce the size of the mechanism.

The present invention can solve the problems of high cost of measurement units, complicated circuit connections, increased power consumption, and increased control complexity in traditional solutions. In addition, compared with existing similar force/position fusion measurement devices, the present invention has two advantages:

1. The present invention can greatly reduce the overall size of the mechanism, which is of great significance to the miniaturization of a rope-driven dexterous hands or a rope-driven robotic arms. This is mainly due to the flexible adjustment of the positions of the visual measurement unit and the drive unit of the present invention. Specifically, the present invention transforms the drive unit layout into a truncated cone shape and places the visual measurement unit at the bottom of the truncated cone shape, so that the camera can completely observe the spring deformation information of all joints connected in series, thereby obtaining the force and position information of all joints. However, if the existing similar devices are used for force/position measurement of a large number of joints, the size of its mechanism will be greatly increased. It requires the use of multiple cameras or sacrificing accuracy (increasing the distance between the camera and the target), so its volume, cost and accuracy are not as good as the effects brought by the present invention.

2. The present invention has improved the way the marking points on both ends of the spring are fixed. The recognition algorithm usually used to identify the spring deformation amount in the prior art is to identify the characteristics of the spring itself (such as spring hook or spring color) and paste circular marking points on the spring, and reflect the spring deformation amount by identifying the circular marking points. Directly identifying contours is more complicated than identifying spherical marker points, so it requires higher processor performance. To identify spherical marker points, it is only needed to identify simple geometric features such as circles, so the identification is fast and has high accuracy. However, the springs, ropes and T-nuts in the prior art are directly connected in series, so the marking points can generally only be fixed with double-sided tape. However, this brings another difficulty, that is: during the rope stretching process, because the spring hook is not completely fixed with the T-nut, this will cause the marking point attached to the spring to easily slip and deflect left and right, which will greatly affect the accuracy of the visual inspection unit.

The solution of the present invention is to fix the hook ends of the spring with the square slider through pins, and there is a circular marker point above the square slider. There are small holes at both ends of the square slider, which can be penetrated into the guide rail to ensure that when the spring deforms, the marker point will not shift, but will follow the direction of the spring deformation.

According to the freedom requirements of dexterous hands, a plurality of motors are needed to complete the drive, so the transmission unit is composed of plurality of driving modules. Each driving module is formed by a motor, a reducer, a T-shaped screw, a T-nut, tension spring, a rope, and a marker. In order to ensure the measurement accuracy of the spring by the measurement unit while reducing the size of the mechanism, the arrangement of the driving modules becomes particularly important. There are three options:

Option 1: If all driving modules are arranged in a cylindrical shape, the tension of the spring cannot be measured with a monocular camera (because it is on a straight line, and the monocular camera cannot output depth information), so only a binocular camera can be used. There are very few binocular cameras with high accuracy and frame rate on the market, and only two monocular cameras can be combined. With cylindrical arrangement, its size depends on the size of the camera and the distance between the cameras.

Option 2: If all driving modules are arranged in a truncated cone shape, since the deformation of the spring and the camera are not in a straight line, a monocular camera can be used. However, there are requirements for the inclination angle of the circular cone. Obviously, the closer the inclination angle is to 45 degrees, the higher the recognition accuracy will be. However, such a large tilt angle will make the diameter of the lower bottom surface of the circular cone very large. At this point, the size of the mechanism is also limited by the tilt angle.

Option 3: If all driving modules are arranged in a truncated cone shape and a binocular camera is used for measurement, the two monocular cameras that form the binocular can be placed upright or on both sides along the busbar direction. The term busbar refers to the generatrix of a geometric shape, a truncated cone, in mathematics. At this point, the influence of the tilt angle is small and can be comprehensively considered based on the desired mechanism volume and accuracy. The advantage of upright display is that the software processing is simple and no correction is required; the disadvantage is that the effective information will only appear in part of the camera's field of view, resulting in a higher single-pixel error occupied by the effective information. When cameras are placed on both sides along the busbar direction, the overlapping field of view of the two monocular cameras is larger, and the single-pixel error is much smaller than that of the upright camera.

Based on the comprehensive comparison of the three options, the measurement and placement layout of the option 3 has more advantages in terms of accuracy and volume.

Through the unique joint transmission and tendon arrangement design of the present invention, the measurement unit (such as a camera) can simultaneously identify the deformation amount of all tension springs, so that the torque and angle of each joint can be obtained through calculation. In this solution, only one binocular camera is needed to detect the force and position information that can only be observed by many sets of force (or torque) sensors and angle sensors. Therefore, it can solve the problems of high cost of measurement units, complex circuit connections, increased power consumption, and increased control complexity in traditional solutions.

Compared with the existing technology, the measurement unit consists of two industrial cameras forming a binocular vision measurement solution, which has higher resolution and frame rate than commercial binocular cameras. The existing technology usually uses a monocular camera to identify the deformation of the spring, which has lower accuracy than binocular cameras. On the other hand, the monocular solution has higher requirements for the tilt angle of each transmission module. Because the larger the tilt angle, the overall size of the forearm of the dexterous hand will be larger, which is not conducive to the lightweight mechanism.

Preferred Embodiment 2: This embodiment is described with reference to FIGS. 1 to 10. According to this embodiment, the thumb 21, the index finger 22 and the middle finger 23 are all three-wheel-drive finger mechanisms 380, the three-wheel-drive finger mechanism 380 is connected to three drive measurement units I respectively, the ring finger 24 and the little finger 25 are both two-wheel-drive finger mechanisms 260, the two-wheel-drive finger mechanism 260 is connected to two drive measurement units I respectively. The undisclosed technical features in this embodiment are the same as those in the Preferred Embodiment 1.

There are a total of 13 drive measurement units I, and each drive measurement unit I is connected to one active flexion joint of a finger.

Preferred Embodiment 3: This embodiment is described with reference to FIGS. 1 to 10. According to this embodiment, the drive measurement unit I comprises a rope 17, a tension spring 5, a fixed frame 12, a driving unit 100 and a linear movement unit 200, the driving unit 100 is fixed on the fixed frame 12, an output end 101 of the driving unit 100 is connected to an input end 202 of the linear movement unit 200, the tension spring 5 is slidingly connected to the fixed frame 12 through a sliding component 300, an execution end 201 of the linear movement unit 200 is fixedly connected to a rear end of the tension spring 5, a front end of the tension spring 5 is fixedly connected to one end of the rope 17, another end of the rope 17 is fixedly connected to the finger joint 400, the depth camera 10 is arranged to face the tension spring 5. The undisclosed technical features in this embodiment are the same as those in the Preferred Embodiment 2.

The tension spring 5 is arranged on a front side of the linear moving unit 200.

Preferred Embodiment 4: This embodiment is described with reference to FIGS. 1 to 10. According to this embodiment, both the front end and the rear end of the tension spring 5 are fixedly connected to connecting heads 14 respectively, the connecting heads 14 are slidingly connected to the sliding component 300, the connecting head 14 at the rear end has one side vertically fixed with a spring B end marking point 8, the connecting head 14 at the front end has one side vertically fixed with a spring A end marking point 4. The undisclosed technical features in this embodiment are the same as those in the Preferred Embodiment 3.

The depth camera 10 is fixed on a rear side of the driving unit 100 through a camera bracket 11, and a height of the spring A end marking point 4 is higher than a height of the spring B end marking point 8.

Preferred Embodiment 5: This embodiment is described with reference to FIGS. 1 to 10. According to this embodiment, the linear movement unit 200 comprises a guide rail 13, a T-shaped screw 7 and a T-shaped nut 3, the guide rail 13 is mounted on the fixed frame 12, and the T-shaped screw 7 and the guide rail 13 are arranged in parallel to each other, a rear end of the T-shaped screw 7 is connected to the output end of the driving unit, the T-shaped nut 3 is screwed onto the T-shaped screw 7, an outside of the T-shaped screw 7 is sleeved on the guide rail 13, and the rear end of the tension spring 5 is fixedly connected to a front end face of the T-shaped nut 3. The undisclosed technical features in this embodiment are the same as those in the Preferred Embodiment 3.

The fixed frame 12 comprises a bottom plate 121, a rear connecting plate 122, a middle connecting plate 123 and a front connecting plate 124. The rear connecting plate, the middle connecting plate and the front connecting plate are vertically fixed on the upper end surface of the bottom plate in sequence from back to front. The driving unit 100 is mounted at a rear end of the rear connecting plate, the guide rail 13 is vertically fixed between the middle connecting plate and the rear connecting plate, and the T-shaped screw 7 is arranged between the middle connecting plate and the rear connecting plate and is rotationally connected to the middle connecting plate and the rear connecting plate. The tension spring 5 is arranged between the front connecting plate and the middle connecting plate.

The sliding component 300 comprises two sliding rods 16. The two sliding rods 16 are parallel and vertically mounted between the front connecting plate and the middle connecting plate. The connecting heads 14 are sleeved on an outer side of the two sliding rods 16 and are slidingly connected with the sliding rods 16.

Preferred Embodiment 6: This embodiment is described with reference to FIGS. 1 to 10. According to this embodiment, a connecting rod 15 is vertically fixed between a rear end face of the connecting head 14 at the rear end and a front end face of the T-shaped nut 3, the connecting rod 15 is inserted through the middle connecting plate and is slidingly connected to the middle connecting plate. The undisclosed technical features in this embodiment are the same as those in the Preferred Embodiment 5.

The driving unit 100 comprises a drive motor 1, a reducer 6 and a coupling 2. The motor shaft of the drive motor 1 is connected to the input shaft of the reducer 6. The output shaft of the reducer 6 is connected to the input end of the linear movement unit through the coupling 2.

The front end of the fixed frame 12 is provided with a guide pulley set 9, and the other end of the rope 17 bypasses the guide pulley set 9 and is fixedly connected to a finger joint.

Preferred Embodiment 7: This embodiment is described with reference to FIGS. 1 to 10. According to this embodiment, the two-wheel-drive finger mechanism comprises a two-wheel-drive first flexion joint 26, a two-wheel-drive first flexion knuckle 27, a two-wheel-drive second flexion joint 28, a two-wheel-drive second flexion knuckle 29, a two-wheel-drive third flexion joint 30 and a two-wheel-drive third flexion knuckle 31, the two-wheel-drive first flexion joint 26 are arranged on the palm 20, an outer sidewall of the two-wheel-drive first flexion joint 26 is fixed with the rope 17 of the drive measurement units I, a front end of the two-wheel-drive first flexion joint 26 is fixed with a rear end of the two-wheel-drive first flexion knuckles 27, the two-wheel-drive second flexion joint 28 is arranged at a front end of the two-wheel-drive first flexion knuckles 27, an outer sidewall of the two-wheel-drive second flexion joint 28 are fixed with the rope 17 of the drive measurement units I, a front end of the two-wheel-drive second flexion joint 28 is fixed with a rear end of the two-wheel-drive second flexion knuckles 29, the two-wheel-drive third flexion joint 30 is arranged at a front end of the two-wheel-drive second flexion knuckles 29, an outer sidewall of the two-wheel-drive third flexion joint 30 is fixed to the outer sidewall of the two-wheel-drive second flexion joint 28 through a two-wheel-drive passive rope 32, a front end of the two-wheel-drive third flexion joint 30 is fixed with a rear end of the two-wheel-drive third flexion knuckle 31, two sides of the two-wheel-drive third flexion knuckle 31 are respectively fixed with one end of a two-wheel-drive reset rope 33, another ends of the two-wheel-drive reset ropes 33 are arranged to bypass outer sides of the two-wheel-drive second flexion joint 28 and the two-wheel-drive first flexion joint 26 respectively and then connected to one end of a two-wheel-drive reset spring 34 respectively, another ends of the two-wheel-drive reset springs 34 are arranged on the palm 20. The undisclosed technical features in this embodiment are the same as those in the Preferred Embodiment 3.

The ring finger and little finger use the same mechanism, both have 3 degrees of freedom (3 finger joints) and are driven by 2 drive motors of 2 drive measurement units I respectively. According to bionics research on human fingers, the ring finger and little finger play an auxiliary role in the grasping process, so they do not have the freedom to swing sideways in the present invention. The two-wheel-drive second flexion joint 28 and the two-wheel-drive first flexion joint 26 are active flexion joints, and the two-wheel-drive third flexion joint 30 is passive joint. When the joint is bent, the two-wheel-drive reset spring 34 will be elongated; when the joint is to be reset, the two-wheel-drive reset spring 34 will provide a restoring force.

Preferred Embodiment 8: This embodiment is described with reference to FIGS. 1 to 10. According to this embodiment,
the two-wheel-drive finger mechanism further comprises three two-wheel-drive guide pulleys 35, the three two-wheel-drive guide pulleys 35 are arranged at the front end of the palm 20, one two-wheel-drive guide pulleys 35 is arranged on a rear side of the two-wheel-drive first flexion joint 26, and the other two two-wheel-drive guide pulleys 35 are respectively arranged on two sides of an axis of the two-wheel-drive first flexion joint 26, the rope 17 affixed at the outer sidewall of the two-wheel-drive second flexion joint 28 are arranged to sequentially bypass the three two-wheel-drive guide pulleys 35 and pass through the axis of the two-wheel-drive first flexion joint 26. The undisclosed technical features in this embodiment are the same as those in the Preferred Embodiment 7.

Through the special arrangement of the three two-wheel-drive guide pulleys 35, the rope passes through the axis O of the two-wheel-drive first flexion joint 26, thereby decoupling it from the two-wheel-drive first flexion joint 26. That is to say, the rotation of the two-wheel-drive first flexion joint 26 will not affect the angle of the two-wheel-drive second flexion joint 28, and will not produce force coupling and angle coupling on the finger root joints. There is no need to use additional control means to decouple control between joints.

Preferred Embodiment 9: This embodiment is described with reference to FIGS. 1 to 10. According to this embodiment, the three-wheel-drive finger mechanism comprises a lateral swing base 36, a lateral swing joint 37, a three-wheel-drive first flexion joint 38, a three-wheel-drive first flexion knuckle 39, and a three-wheel-drive second flexion joint 40, a three-wheel-drive second flexion knuckle 41, a three wheel-drive third flexion joint 42 and a three-wheel-drive first flexion joints knuckle 43, the lateral swing base 36 is fixed on the palm 20, the lateral swing joint 37 is arranged on the lateral swing base 36, an outer sidewall of the lateral swing joint 37 is fixed with the rope 17 of the drive measurement units I, a front end of the lateral swing joint 37 is connected to the three-wheel-drive first flexion joint 38, an outer sidewall of the three-wheel-drive first flexion joint 38 is fixed with the rope 17 of another the drive measurement units I, a front end of the three-wheel-drive first flexion joint 38 is fixed with a rear end of the three-wheel-drive first flexion knuckle 39, the three-wheel-drive second flexion joint 40 is arranged at a front end of the three-wheel-drive first flexion knuckle 39, an outer sidewall of the three-wheel-drive second flexion joint 40 is fixed with the rope 17 of third the drive measurement units I, a front end of the three-wheel-drive second flexion joint 40 is connected to a rear end of the three-wheel-drive second flexion knuckle 41, the three-wheel-drive second flexion joint 42 is arranged at a front end of the three-wheel-drive second flexion knuckle 41, an outer sidewall of the three-wheel-drive third flexion joint 42 is fixed to the outer sidewall of the three-wheel-drive second flexion joint 40 through a three-wheel-drive passive rope 44, a front end of the three-wheel-drive third flexion joint 42 is fixed with a rear end of the three-wheel-drive first flexion joints knuckle 43, two sides of the three-wheel-drive first flexion joints knuckle 43 are respectively fixed with one end of a three-wheel-drive reset rope 45, another end of the three-wheel-drive reset rope 45 are arranged to bypass outer sides of the three-wheel-drive second flexion joint 40 and the three-wheel-drive first flexion joint 38 respectively and then connected to one end of a three-wheel-drive reset spring 46 respectively, another end of the three-wheel-drive reset spring 46 is mounted on the palm 20. The undisclosed technical features in this embodiment are the same as those in the Preferred Embodiment 3.

The thumb, index finger and middle finger use the same mechanism, each containing 4 degrees of freedom (4 finger joints) and driven by 3 drive motors of 3 drive measurement units I respectively. The lateral swing joint 37, the three-wheel-drive first flexion joint 38 and the three-wheel-drive second flexion joint 40 are active flexion joints, and the three-wheel-drive third flexion joint 42 is a passive flexion joint. When the joint bends, the three-wheel-drive reset spring 46 will be elongated; when the joint is to be reset, the three-wheel-drive reset spring 46 will provide a restoring force.

Preferably, one additional drive measurement unit I may be provided on the thumb for joint resetting. Alternatively, one additional drive measurement unit I may be provided as a reserve for future increase in degree of freedom.

Preferred Embodiment 10: This embodiment is described with reference to FIGS. 1 to 10. According to this embodiment, the three-wheel-drive finger mechanism further comprises three three-wheel-drive guide pulleys 47, the three three-wheel-drive guide pulleys 47 are arranged at the front end of the palm 20, one three-wheel-drive guide pulleys 47 is arranged on a rear side of the three-wheel-drive first flexion joint 38, and the two three-wheel-drive guide pulleys 47 are respectively arranged on two sides of an axis of the three-wheel-drive first flexion joint 38, the rope 17 affixed at the outer sidewall of the three-wheel-drive second flexion joint 40 are arranged to sequentially bypass three the three-wheel-drive guide pulleys 47 and pass through the axis of the three-wheel-drive first flexion joint 38. The undisclosed technical features in this embodiment are the same as those in the Preferred Embodiment 9.

Through the special arrangement of the three-wheel-drive guide pulleys 47, the rope passes through the axis of the three-wheel-drive first flexion joint 38, thereby decoupling it from the three-wheel-drive first flexion joint 38. That is to say, the rotation of the three-wheel-drive first flexion joint 38 will not affect the angle of the three-wheel-drive second flexion joint 40, and will not produce force coupling and angle coupling on the finger joint. There is no need to use additional control means to perform control decoupling between joints.

Both the flexion joint and the swing joint in the present application are torque transmission wheel structures, and a cable trough is provided on the torque transmission wheel for installing the winding rope.

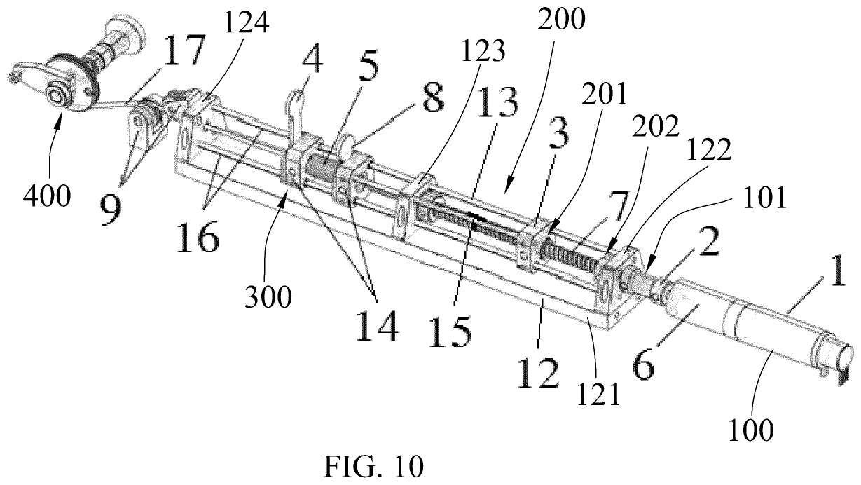

Referring to FIG. 10 of the drawings, the drive motor equipped with the reducer drives the T-shaped screw to rotate, and then the T-shaped nut slides along the guide rail to drive the traction rope. When a pulling force is exerted onto the traction rope, the corresponding joint is driven to rotate. The present invention also provides a brand-new mechanical layout, embedding the visual device at the end of the forearm, and then arranging multiple single-joint modules in a ring smartly, so that the visual device can observe the spring elongation information of all joint modules at the same time.

The measurement method of a smart manipulator with vision-based force and position fusion measurement comprises the following steps:

Step 1: Obtain the spring variation value: The drive motor 1 drives the T-shaped screw 7 to rotate through the reducer 6 and the coupling 2. The T-shaped nut 3 slides along the guide rail 13 to drive the rope 17. The rope 17 pulls the execution end of the joint to rotate. The position change of the tension spring 5 is observed through the depth camera 10.

Step 2: Measure the rotation value at the joint execution end: The joint torque is calculated and obtained based on the elongation value of the tension spring 5, the joint angle is calculated and obtained based on the distance moved by the tail end of the tension spring 5 relative to the initial moment, the motor rotation angle is calculated and obtained based on the distance moved by the head end of the tension spring 5 relative to the initial moment.

The measurement method of joint torque comprises the following steps:

The first step of joint torque measurement: for the tension spring 5 installed at one end of the rope, capture images of the spring B end marking point 8 and the spring A end marking point 4 through the depth cameras 10, and observe an elongation value ΔL of the tension spring 5.

The second step of joint torque measurement: The stiffness k of the tension spring 5 is a known quantity. Since the tension spring 5 is connected to the rope, the force Fₖ on the tension spring 5 is equal to the tension Fₗ on the rope. The calculation formula is as follows:

$${F}_{l} = {F}_{k} = k \cdot Δ L \qquad ( 1 )$$

The third step of joint torque measurement:

When the rope 17 is subjected to tension Fₗ, the torque transmission wheel 18 is driven to rotate. It is known that the radius of the torque transmission wheel 18 is r, then the calculation formula of the joint torque τ is:

$$τ = {F}_{l} \cdot r \qquad ( 2 )$$

So the design in this way realizes and provides the functions of joint torque sensors.

The measurement method of joint angle comprises the following steps:

The first step of joint angle measurement: The end where the tension spring 5 is connected to the rope 17 is marked as the tail end of the tension spring 5, that is, the spring A end marking point 4. At the initial moment t₀, the position x₀ of the spring A end marking point 4 of the tension spring 5 relative to the world coordinate system is measured by the depth cameras 10.

The second step of joint angle measurement: After the joint rotates by angle θ, at this moment t₁, the position x₁ of the spring A end marking point 4 of the tension spring 5 relative to the world coordinate system is measured by the depth cameras 10.

The third step of joint angle measurement:

Since the rope 17 is connected to the tail end of the tension spring 5 and the length of the rope 17 is a fixed value, the distance that the tail end of the tension spring 5 moves is the distance that the rope 17 drives the torque transmission wheel 18 to rotate. The distance that the tail end of the tension spring 5 moves during the time period t₀˜t₁ is x₁−x₀, then the relationship between the joint angle θ and x₁−x₀ is:

$${x}_{1} - {x}_{0} = θ \cdot r \qquad ( 3 )$$

Where r refers to the radius of the torque transmission wheel 18, and the calculation formula of the joint angle can be obtained through transformation:

$$θ = \frac{{x}_{1} - {x}_{0}}{r} \qquad ( 4 )$$

So the design in this way realizes and provides the functions of joint angle encoders.

The measurement method of motor rotation angle comprises the following steps:

The first step of motor rotation angle measurement: The end where the tension spring 5 is fixedly connected to the T-shaped nut 3 is marked as the head end of the tension spring 5, that is, the spring B end marking point 8. At the initial moment t₀, the position y₀ of the spring B end marking point 8 of the tension spring 5 relative to the world coordinate system is measured by the depth cameras 10.

The second step of motor rotation angle measurement: After the joint rotates by angle θ, at this moment t₁, the position y₁ of the spring B end marking point 8 of the tension spring 5 relative to the world coordinate system is measured by the depth cameras 10.

The third step of motor rotation angle measurement: Since the T-shaped nut 3 is connected to the head end of the tension spring 5, the distance that the head end of the tension spring 5 moves is the distance that the T-shaped nut 3 moves on the T-shaped screw 7. The distance that the head end of the tension spring 5 moves during the time period t₀˜t₁ is y₁−y₀, it is known that the stroke of T-shaped screw 7 is one revolution moving distance l, and the reduction ratio of the motor is n:1, then it can be deduced that the motor rotation angle ϕ is:

$$ϕ = \frac{{y}_{1} - {y}_{0}}{l} \cdot n \cdot 2 π \qquad ( 5 )$$

So the design in this way realizes and provides the functions of motor encoders.

The basic principles and main features of the present invention and the advantages of the present invention have been shown and described above. Those skilled in the art should understand that the present invention is not limited by the above embodiments. The above embodiments and descriptions only illustrate the principles of the present invention. Without departing from the spirit and scope of the present invention, there will be various changes and improvements in the present invention, and these changes and improvements will all fall within the scope of the claimed invention. The scope of protection of the present invention is defined by the appended claims and their equivalents.

What is claimed is:

1. A smart manipulator based on vision-based force and position fusion measurement, characterized in that, said manipulator comprising:
a thumb (21), an index finger (22), a middle finger (23), a ring finger (24), a little finger (25), a palm (20), two depth cameras (10) and a plurality of drive measurement units (I),
wherein said plurality of drive measurement units (I) are evenly distributed to form a truncated cone structure, said two depth cameras (10) are symmetrically arranged on a rear end of said plurality of drive measurement units (I) while each said depth camera (10) is respectively arranged along a generatrix direction of the truncated cone structure,
said palm (20) is arranged at a front end of said plurality of drive measurement units (I), and said thumb (21), said index finger (22), said middle finger (23), said ring finger (24) and said little finger (25) are arranged at a front end of said palm (20), each of said thumb (21), said index finger (22), said middle finger (23), said ring finger (24) and said little finger (25) are connected to two or more said drive measurement unit (I) respectively.

2. The smart manipulator based on vision-based force and position fusion measurement according to claim 1, characterized in that, said thumb (21), said index finger (22) and said middle finger (23) are all having three-wheel-drive finger mechanisms (380) respectively, said three-wheel-drive finger mechanism (380) is connected to three said drive measurement units (I) respectively, said ring finger (24) and said little finger (25) are both having two-wheel-drive finger mechanisms (260), said two-wheel-drive finger mechanism (260) is connected to two said drive measurement units (I) respectively.

3. The smart manipulator based on vision-based force and position fusion measurement according to claim 2, characterized in that, said drive measurement unit (I) comprises a rope (17), a tension spring (5), a fixed frame (12), a driving unit (100) and a linear movement unit (200), said driving unit (100) is fixed on said fixed frame (12), an output end of said driving unit (100) is connected to an input end (202) of said linear movement unit (200), said tension spring (5) is slidingly connected to said fixed frame (12) through a sliding component (300), an execution end (201) of said linear movement unit (200) is fixedly connected to a rear end of the tension spring (5), a front end of said tension spring (5) is fixedly connected to one end of said rope (17), another end of said rope (17) is fixedly connected to a finger joint (400), said depth camera (10) is positioned to face said tension spring (5) at the generatrix direction.

4. The smart manipulator based on vision-based force and position fusion measurement according to claim 3, characterized in that, both said front end and said rear end of the tension spring (5) are fixedly connected to connecting heads (14) respectively, said connecting heads (14) are slidingly connected to said sliding component, said connecting head (14) at said rear end is fixed with a spring B end marking point (8) vertically extended from one side of the connecting head (14), said connecting head (14) at said front end is fixed with a spring A end marking point (4) vertically extended from one side of the connecting head (14).

5. The smart manipulator based on vision-based force and position fusion measurement according to claim 3, characterized in that, said linear movement unit comprises a guide rail (13), a T-shaped screw (7) and a T-shaped nut (3), said guide rail (13) is mounted on said fixed frame (12), and said T-shaped screw (7) and said guide rail (13) are arranged in parallel to each other, a rear end of the T-shaped screw (7) is connected to said output end of said driving unit, said T-shaped nut (3) is screwed onto said T-shaped screw (7), an outside of said T-shaped screw (7) is sleeved on said guide rail (13), and said rear end of said tension spring (5) is fixedly connected to a front end face of said T-shaped nut (3).

6. The smart manipulator based on vision-based force and position fusion measurement according to claim 5, characterized in that, a connecting rod (15) is vertically fixed between a rear end face of said connecting head (14) at said rear end and a front end face of said T-shaped nut (3), said connecting rod (15) is inserted into a middle connecting plate and is slidingly connected to said middle connecting plate.

7. The smart manipulator based on vision-based force and position fusion measurement according to claim 3, characterized in that, said two-wheel-drive finger mechanism (260) comprises a two-wheel-drive first flexion joint (26), a two-wheel-drive first flexion knuckle (27), a two-wheel-drive second flexion joint (28), a two-wheel-drive second flexion knuckle (29), a two-wheel-drive third flexion joint (30) and a two-wheel-drive third flexion knuckle (31), said two-wheel-drive first flexion joint (26) are arranged on said palm (20), an outer sidewall of said two-wheel-drive first flexion joint (26) is fixed with said rope (17) of said drive measurement units (I), a front end of said two-wheel-drive first flexion joint (26) is fixed with a rear end of said two-wheel-drive first flexion knuckles (27), said two-wheel-drive second flexion joint (28) is arranged at a front end of said two-wheel-drive first flexion knuckles (27), an outer sidewall of said two-wheel-drive second flexion joint (28) are fixed with said rope (17) of said drive measurement units (I), a front end of said two-wheel-drive second flexion joint (28) is fixed with a rear end of said two-wheel-drive second flexion knuckles (29), said two-wheel-drive third flexion joint (30) is arranged at a front end of said two-wheel-drive second flexion knuckles (29), an outer sidewall of said two-wheel-drive third flexion joint (30) is fixed to said outer sidewall of said two-wheel-drive second flexion joint (28) through a two-wheel-drive passive rope (32), a front end of said two-wheel-drive third flexion joint (30) is fixed with a rear end of said two-wheel-drive third flexion knuckle (31), two sides of said two-wheel-drive third flexion knuckle (31) are respectively fixed with one end of a two-wheel-drive reset rope (33), another ends of said two-wheel-drive reset ropes (33) are arranged to bypass outer sides of said two-wheel-drive second flexion joint (28) and said two-wheel-drive first flexion joint (26) respectively and then connected to one end of a two-wheel-drive reset spring (34) respectively, another ends of said two-wheel-drive reset springs (34) are arranged on said palm (20).

8. The smart manipulator based on vision-based force and position fusion measurement according to claim 7, characterized in that, said two-wheel-drive finger mechanism (260) further comprises three two-wheel-drive guide pulleys (35), all said three two-wheel-drive guide pulleys (35) are arranged at said front end of said palm (20), one said two-wheel-drive guide pulleys (35) is arranged on a rear side of said two-wheel-drive first flexion joint (26), and another two said two-wheel-drive guide pulleys (35) are respectively arranged on two sides of an axis of said two-wheel-drive first flexion joint (26), said rope (17) affixed at said outer sidewall of said two-wheel-drive second flexion joint (28) are arranged to sequentially bypass three said two-wheel-drive guide pulleys (35) and pass through said axis of said two-wheel-drive first flexion joint (26).

9. The smart manipulator based on vision-based force and position fusion measurement according to claim 3, characterized in that, said three-wheel-drive finger mechanism (380) comprises a lateral swing base (36), a lateral swing joint (37), a three-wheel-drive first flexion joint (38), a three-wheel-drive first flexion knuckle (39), and a three-wheel-drive second flexion joint (40), a three-wheel-drive second flexion knuckle (41), a three wheel-drive third flexion joint (42) and a three-wheel-drive first flexion joints knuckle (43), said lateral swing base (36) is fixed on said palm (20), said lateral swing joint (37) is arranged on said lateral swing base (36), an outer sidewall of said lateral swing joint (37) is fixed with said rope (17) of said drive measurement units (I), a front end of said lateral swing joint (37) is connected to said three-wheel-drive first flexion joint (38), an outer sidewall of said three-wheel-drive first flexion joint (38) is fixed with said rope (17) of another said drive measurement units (I), a front end of said three-wheel-drive first flexion joint (38) is fixed with a rear end of said three-wheel-drive first flexion knuckle (39), said three-wheel-drive second flexion joint (40) is arranged at a front end of said three-wheel-drive first flexion knuckle (39), an outer sidewall of said three-wheel-drive second flexion joint (40) is fixed with said rope (17) of third said drive measurement units (I), a front end of said three-wheel-drive second flexion joint (40) is connected to a rear end of said three-wheel-drive second flexion knuckle (41), said three-wheel-drive second flexion joint (42) is arranged at a front end of said three-wheel-drive second flexion knuckle (41), an outer sidewall of said three-wheel-drive third flexion joint (42) is fixed to said outer sidewall of said three-wheel-drive second flexion joint (40) through a three-wheel-drive passive rope (44), a front end of said three-wheel-drive third flexion joint (42) is fixed with a rear end of said three-wheel-drive first flexion joints knuckle (43), two sides of said three-wheel-drive first flexion joints knuckle (43) are respectively fixed with one end of a three-wheel-drive reset rope (45), another end of said three-wheel-drive reset rope (45) are arranged to bypass outer sides of said three-wheel-drive second flexion joint (40) and said three-wheel-drive first flexion joint (38) respectively and then connected to one end of a three-wheel-drive reset spring (46) respectively, another end of said three-wheel-drive reset spring (46) is mounted on said palm (20).

10. The smart manipulator based on vision-based force and position fusion measurement according to claim 9, characterized in that, said three-wheel-drive finger mechanism (380) further comprises three three-wheel-drive guide pulleys (47), all said three three-wheel-drive guide pulleys (47) are arranged at said front end of said palm (20), one said three-wheel-drive guide pulleys (47) is arranged on a rear side of said three-wheel-drive first flexion joint (38), and another two said three-wheel-drive guide pulleys (47) are respectively arranged on two sides of an axis of said three-wheel-drive first flexion joint (38), said rope (17) affixed at said outer sidewall of said three-wheel-drive second flexion joint (40) are arranged to sequentially bypass three said three-wheel-drive guide pulleys (47) and pass through said axis of said three-wheel-drive first flexion joint (38).
